(19) United States
(12) Patent Application Publication
(10) Pub. No.: US 2019/0034668 A1
(43) Pub. Date: Jan. 31, 2019

(54) DOCKING COMPUTING DEVICES TO A DOCKING STATION

(71) Applicant: HEWLETT-PACKARD DEVELOPMENT COMPANY, L.P., Houston, TX (US)

(72) Inventors: Manny NOVOA, Cypress, TX (US); Aaron SANDERS, Houston, TX (US); Javier Enrique GUERRERO, Houston, TX (US)

(73) Assignee: HEWLETT-PACKARD DEVELOPMENT COMPANY, L.P., Houston, TX (US)

(21) Appl. No.: 16/074,742

(22) PCT Filed: Sep. 7, 2016
(86) PCT No.: PCT/US2016/050538

§ 371 Date: Aug. 1, 2018

(51) Int. Cl. G06F 21/85; G06F 21/62; G06F 13/40

(52) U.S. Cl. CPC G06F 21/85; G06F 13/4068; G06F 21/6218

(57) ABSTRACT

Examples disclosed herein provide the ability for a docking station to authorize a user to utilize the docking station. In one example method, the docking station determines whether a computing device is docked to the docking station and, upon determining the computing device is docked to the docking station, the docking station determines whether a user associated with the computing device is an authorized user of the docking station. As an example, if the user is an authorized user of the docking station, the docking station enables ports of the docking station for access by the computing device.

### BACKGROUND

Point of sale (POS) systems provide the ability for businesses to interact with their customers. As an example, in retail environments, businesses may desire to have the flexibility to easily transition between POS systems that are connected to a host of peripherals, and POS systems that are more mobile (e.g., mobile POS systems), in order to serve customer needs. For example, there may be situations where it is appropriate have a POS system that is stationary and connected to peripherals, such as a barcode scanner, receipt printer, keyboard, and cash drawer. However, there may be other situations where a mobile POS (mPOS) system may be more appropriate, such as meeting customer needs throughout the store (e.g., verifying prices, searching for inventory, and completing sales transactions throughout the store). By being able to transition a single POS system between a stationary POS system and a mobile POS system, businesses may be able to adapt to the sales flow, in order to meet customer needs and deliver an exceptional experience.

### BRIEF DESCRIPTION OF THE DRAWINGS

FIG. 1 illustrates a docking station that can be used for transitioning between different types of POS systems, according to an example;

FIG. 2 illustrates additional components of the docking station, such as various input/output (I/O) ports that may be enabled or disabled for access by a tablet computer that is dockable to the docking station, according to an example;

FIG. 3 illustrates the docking station for authenticating users, in order to secure computing devices, associated with authenticated users, to the docking station, and provide access to peripherals attached to ports of the docking station, according to an example; and

FIG. 4 is a flow diagram in accordance with an example of the present disclosure.

### DETAILED DESCRIPTION

Examples disclosed herein provide the ability to securely transition between different types of POS systems, such as a stationary POS system and an mPOS system, according to an example. As will be further described, a mobile computing device, such as a tablet computer, may be dockable to a docking station, in order to transition between the different types of POS systems. In order to control access to peripherals attached to ports of the docking station, and secure the tablet computer to the docking station (e.g., to prevent unauthorized removal), users may be authorized prior to accessing the POS system. As will be further described, multi-factor authentication may be included in the docking station as well, that restricts a user, for example, from accessing peripherals from certain ports of the docking station (e.g., cash drawer), based on the amount of authentication provided by the user. By authorizing the user, rather than the computing device that is docked to the docking station, the user is not limited to any particular computing device. Rather, the user has the capability to use any computing device that is dockable to the docking station.

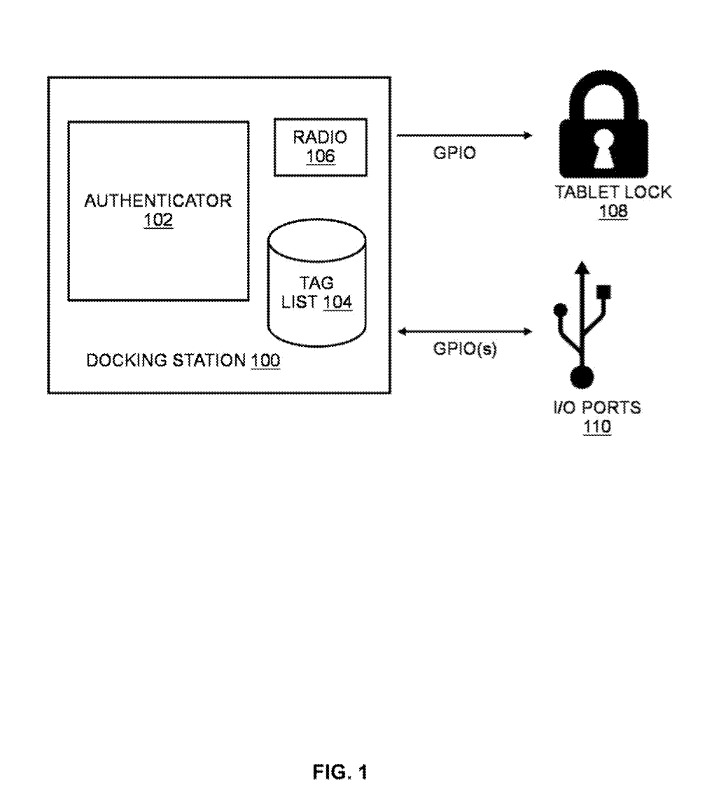

With reference to the figures, FIG. 1 illustrates a docking station 100 that can be used for transitioning between different types of POS systems, such as a stationary POS system and an mPOS system, according to an example. As will be further described, the docking station 100 may be used for securing a computing device, such as a tablet computer, via a tablet lock 108, and controlling access of the tablet computer to peripherals connected to input/output (I/O) ports 110 of the docking station 100. As an example, users may be authorized prior to docking or undocking the tablet computer to or from the docking station 100, and being able to access the peripherals connected to the I/O ports 110. As an example, control of the tablet lock 108 and the I/O ports 110 may be provided by the use of general-purpose I/O (GPIO) pins. With regards to the tablet lock 108, the GPIO pin may be toggled in order to control an actuator/solenoid that may be used for securing the tablet computer to the docking station 100.

As an example, the docking station 100 may include an authenticator 102 for performing the user authorization described above. For example, the authenticator 102 may communicate with the tablet computer, via a radio 106, and/or various hardware components of the docking station 100 in order to authenticate a user attempting to use or utilize the docking station 100. The docking station 100 may use the radio 106 to communicate with the tablet computer or another form of user-based identification, such as a user badge, using various communications technologies, such as radio-frequency identification (RFID) and near field communication (NFC). For example, an RFID tag or NFC controller in the tablet computer or user badge may be used to communicate with the radio 106 of the docking station, in order to authenticate a user of the tablet computer to utilize the docking station 100. However, various hardware components of the docking station 100 may be used instead, for authenticating a user attempting to utilize the docking station 100. Examples of other hardware component of the docking station 100 that may be used for user authentication include, but are not limited to, biometric solutions or PIN-based user authentication (e.g., keypad for entering a pin). Examples of biometric solutions include, but are not limited to, fingerprint, face recognition, iris recognition, and voice recognition.

As an example, when authenticating a user, rather than using any of the various options described above as a single form of authentication, the various forms of authentication may be used in combination, as levels for multi-factor authentication. For example, based on the amount of authentication provided by the user, the user may be restricted from utilizing certain features of the docking station. The various options described above for authenticating a user that includes, but are not limited to, a user badge, PIN-based user authentication, and biometric solutions, may be ranked based on the level of security that each option provides. For example, a user badge may have a lower level of security, and if a user attempts to access the docking station 100 by authenticating with the user badge, the authenticator 102 may grant limited permissions to certain docked peripherals. However, another option for authenticating the user, such as biometric solutions, may provide a greater level of security for ensuring that it is actually the user attempting to access the docking station 100, and if such authentication is provided by the user, the authenticator 102 may provide a greater amount of access to the docking station, such as all the peripherals connected to the docking station 100. As an example, the various biometric solutions mentioned above may be ranked as well, in order to provide various levels of access to the docking station.

By having the capability to perform user authorization or authentication, as described above, the docking station may require compute capability. For example, the docking station may include control circuitry for latching and locking the tablet computer to the docking station 100, and software/firmware to process user authentications that gate control actuation of the latching/locking mechanisms. As will be further described, the docking station may include a tag list 104, or database, of users that are authorized to dock computing devices to the docking station and utilize at least a set of the I/O ports 110 and their associated peripherals. For example, some users may have access to a first set of the I/O ports 110, and other users may have access to a second and different set of the I/O ports 110 from the first set. As users authorized to utilize the docking station 100 may change, the tag list 104 may provide the ability to dynamically control the list of users that have access to the docking station 100 at any particular moment. As an example, the docking station 100 may be securely coupled to a server or managerial workstation that maintains the tag list 104, which corresponds to a secure database of registered user credentials that have the permission to utilize the docking station 100. This communication to back end database services may work via a service running on the tablet computer that is dockable to the docking station 100. As an example of the multi-factor authentication described above, a user may be required to provide certain levels of authentication, in order to be able to modify the tag list 104 and control the list of users that have access to the docking station 100, such as a manager.

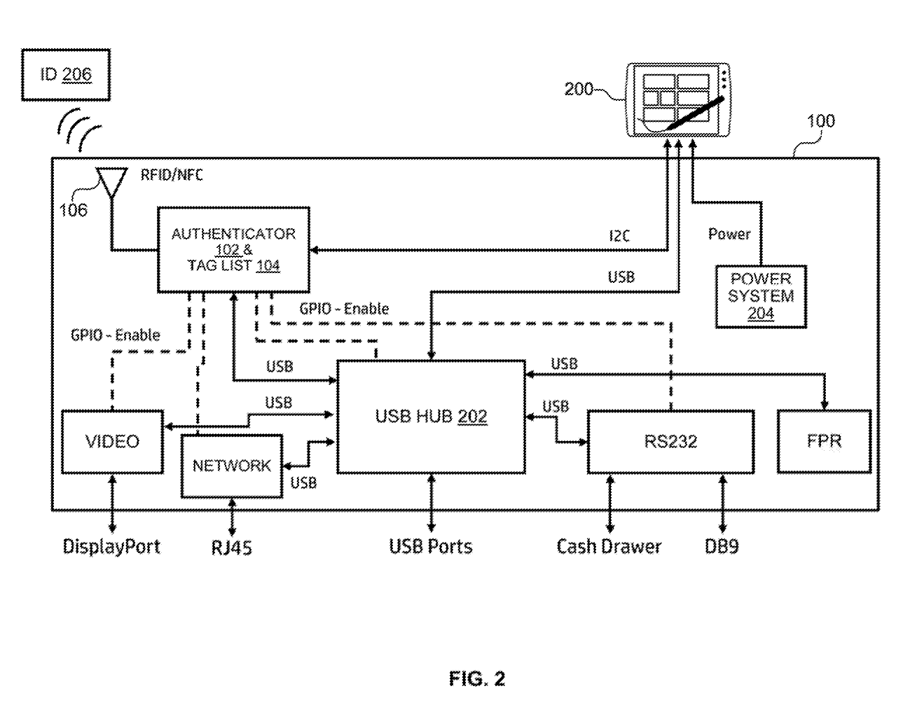

FIG. 2 illustrates additional components of the docking station 100, such as various I/O ports that may be enabled or disabled for access by a tablet computer 200 that is dockable to the docking station 100, according to an example. Once an attempt is made to dock the tablet computer 200 to the docking station 100, the tablet computer 200 may receive power from a power system 204 of the docking station. In addition, the tablet computer 200 may communicate with the authenticator 102 of the docking station via inter-integrated circuit (I²C). However, other forms of communication may be used as well.

As described above, the authenticator 102, via the radio 106, may communicate with a user-based form of identification 206, or the tablet computer 200 itself, in order to authenticate whether a user in the tag list 104 is attempting to utilize the docking station 100. Once authentication takes place, the user may have the tablet computer 200 locked in place with the docking station 100 and be given access to at least a set of the I/O ports illustrated. As an example, upon latching the tablet computer 200, the tablet computer 200 may be automatically locked to the docking station 100 and require user authorization/authentication again in order to release the tablet computer. For example, when the user is ready to unlock the tablet computer 200 from the docking station, for example, to use the tablet computer 200 as an mPOS, once authentication takes place, the user may then be able to unlatch the tablet computer from the docking station 100. However, if an unauthorized user attempts to remove the tablet computer 200 (e.g., credentials associated with the user are not found in the tag list 104), the locking mechanism provided by the docking station (e.g., tablet lock 108) may prevent removal or theft of the tablet computer 200.

With regards to enabling only a set of the I/O ports, as described above with respect to multi-factor authentication, the GPIO-Enable signal (dashed lines) for a particular port may be controlled. For example, if a particular user is not to have access to the cash drawer, once that user is authenticated, the authenticator 102 may set the GPIO-Enable signal for RS232 to 0 or turned off, in order to prevent for the authenticated user from accessing the cash drawer. In addition to enabling only a set of the I/O ports, based on a particular user, the set of I/O ports that are enabled for users may also be based on the time of day. For example, it may be undesirable to provide access to certain peripherals connected to the docking station after hours (e.g., the cash drawer).

As illustrated, the docking station 100 may include a number of GPIO-Enable signals from the authenticator 102 to various I/O ports of the docking station 100, in order to enable an assigned set of ports for each authenticated user. As an example, such information may be included in the tag list 104. The number of GPIO-Enable signals and the categories of I/O ports (e.g., USB) may vary from what is illustrated. For example, although a USB hub 202 is included for connecting peripherals that correspond to USB technology, other types of connection technologies may be used by the docking station 100 as well. As an example, if an unauthorized user attempts to access the tablet computer 200, or any peripherals connected to the docking station 100 (e.g., credentials associated with the user are not found in the tag list 104), all the GPIO-Enable signals may be set to 0 or turned off, preventing the unauthorized user from undocking the tablet computer 200, or using any of the peripherals connected to the docking station 100.

As an example, all events of the tablet computer 200 with the docking station 100, such as latching/unlatching or locking/unlocking will be logged and time-stamped. Logging such events may allow for forensic analysis of usage patterns, and may be used for auditing purposes, to ensure whether or not only authorized users are utilizing the docking station 100. The log of such events may be stored locally on the docking station 100 and/or recorded on a service running on the tablet computer 200 upon latching or locking with the docking station 100.

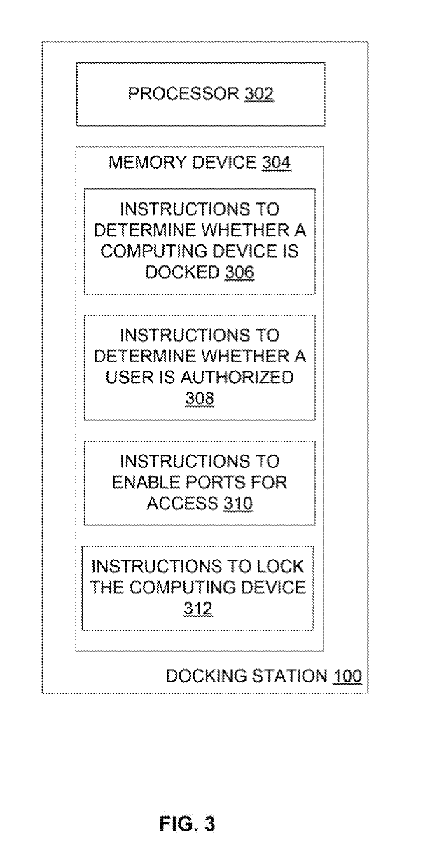

FIG. 3 illustrates the docking station 100 for authenticating users, in order to secure computing devices, associated with authenticated users, to the docking station 100, and provide access to peripherals attached to ports of the docking station 100, according to an example. The docking station 100 depicts a processor 302 and a memory device 304 and, as an example of the docking station 100 performing its operations, the memory device 304 may include instructions 306-312 that are executable by the processor 302. Thus, memory device 304 can be said to store program instructions that, when executed by processor 302, implement the components of the docking station 100. The executable program instructions stored in the memory device 304 include, as an example, instructions to determine whether a computing device is docked (306), instructions to determine whether a user is authorized (308), instructions to enable ports for access (310), and instructions to lock the computing device (312).

Instructions to determine whether a computing device is docked (306) represent program instructions that when executed by the processor 302 cause the docking station 100 to determine when a computing device, such as the tablet computer 200, is docked to the docking station. Referring to FIG. 2, this may occur when power is delivered from the power system 204 upon a device being docked to the docking station 100, or when communication is established on the I²C line between a device and the authenticator 102.

Instructions to determine whether a user is authorized (308) represent program instructions that when executed by the processor 302 cause the docking station 100 determine whether a user associated with the computing device docked to the docking station is an authorized user of the docking station 100. Referring back to FIG. 2, the authenticator 102, via the radio 106, may communicate with a user-based form of identification 206, or the tablet computer 200 itself, in order to authenticate whether a user in the tag list 104 is attempting to utilize the docking station 100. If the user is not an authorized user of the docking station 100, the authenticator 102 may disable the GPIO-Enable signals so that the user will not have access to the peripherals connected to I/O ports of the docking station 100. In addition, if the unauthorized user is attempting to remove a tablet computer 100 that was previously locked to the docking station, the tablet computer 100 may remain locked to prevent the unauthorized user from removing the tablet computer 100.

Instructions to enable ports for access (310) represent program instructions that when executed by the processor 302 cause the docking station 100, upon determining the user is an authorized user of the docking station 100, to enable ports of the docking station 100 for access by the computing device. As described above, the ports of the docking station 100 that the user has access to may depend on multi-factor authentication, which corresponds to the amount of authentication provided by the user. Referring back to FIG. 2, the GPIO-Enable signals for the ports the authorized user is to have access to may be set to 1 or turned on. Similarly, if the user is not have to access to certain ports, such as the cash drawer, the authenticator 102 may set the GPIO-Enable signal for RS232 to 0 or turned off, in order to prevent for the authenticated user from accessing the cash drawer. As a result, each user found in the tag list 104 may have different sets of 110 ports that they may have access to.

Instructions to lock the computing device (312) represent program instructions that when executed by the processor 302 cause the docking station 100, upon determining the user is an authorized user of the docking station 100, to lock the computing device to the docking station 100 until the user, or another authorized user is to authenticate release of the computing device from the docking station 100. As an example, a GPIO pin may be toggled in order to control an actuator/solenoid that may be used for securing the computing device to the docking station 100. This may prevent unauthorized users from removing the computing device from the docking station.

Memory device 304 represents generally any number of memory components capable of storing instructions that can be executed by processor 302. Memory device 304 is non-transitory in the sense that it does not encompass a transitory signal but instead is made up of at least one memory component configured to store the relevant instructions. As a result, the memory device 304 may be a non-transitory computer-readable storage medium. Memory device 304 may be implemented in a single device or distributed across devices. Likewise, processor 304 represents any number of processors capable of executing instructions stored by memory device 304. Processor 302 may be integrated in a single device or distributed across devices. Further, memory device 304 may be fully or partially integrated in the same device as processor 302, or it may be separate but accessible to that device and processor 302.

In one example, the program instructions 306-312 can be part of an installation package that when installed can be executed by processor 302 to implement the components of the docking station 100. In this case, memory device 304 may be a portable medium such as a CD, DVD, or flash drive or a memory maintained by a server from which the installation package can be downloaded and installed. In another example, the program instructions may be part of an application or applications already installed. Here, memory device 304 can include integrated memory such as hard drive, solid state drive, or the like.

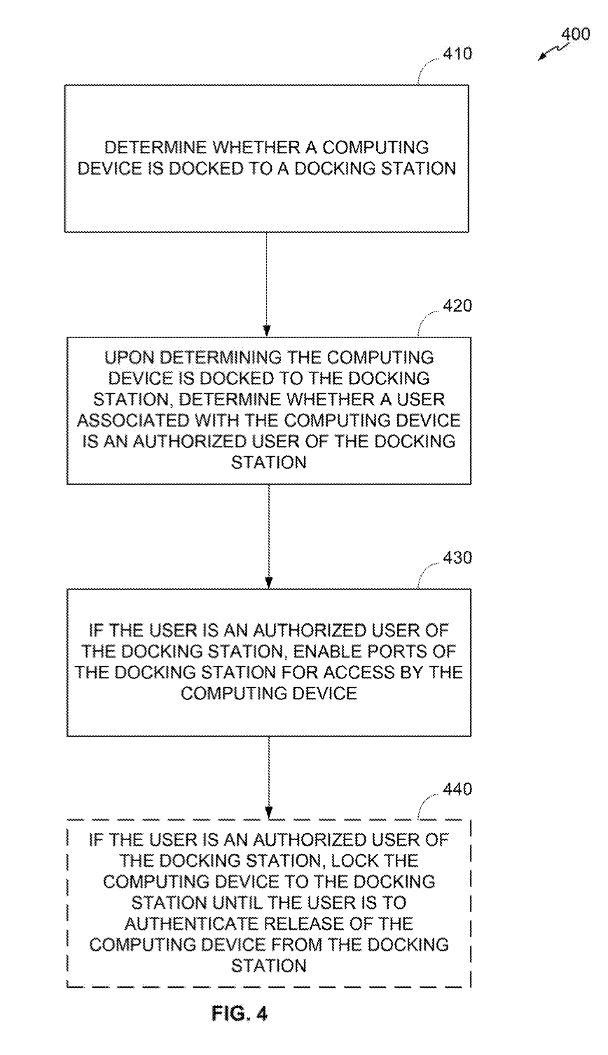

FIG. 4 is a flow diagram 400 of steps taken by a docking station to authenticate users, in order to secure computing devices, associated with authenticated users, to the docking station, and provide access to peripherals attached to ports of the docking station, according to an example. In discussing FIG. 4, reference may be made to the example docking station 100 illustrated in FIGS. 1-3. Such reference is made to provide contextual examples and not to limit the manner in which the method depicted by FIG. 4 may be implemented.

At 410, the docking station may determine whether a computing device is docked to the docking station. Referring to FIG. 2, this may occur when power is delivered from the power system 204 upon a device being docked to the docking station 100, or when communication is established on the I²C line between a device and the authenticator 102.

At 420, upon determining the computing device is docked to the docking station, the clocking station may determine whether a user associated with the computing device is an authorized user of the docking station. As an example, the docking station may determine whether the user is an authorized user of the docking station by looking up a database to determine whether the database includes information concerning the user. The information concerning the user may include data that can be validated by the docking station, such as biometric information concerning the user. Examples of biometric solutions include, but are not limited to, fingerprint, face recognition, iris recognition, and voice recognition. In order to provide a dynamic environment, where the list of authorized users can change, the database may be modified to include other users that are authorized to use the docking station.

At 430, if the user is an authorized user of the docking station, the docking station may enable ports of the docking station for access by the computing device. However, if the user is not an authorized user of the docking station, the docking station may prevent access, by the computing device, to peripherals connected to the ports of the docking station. As an example, the database may include a set of the ports of the docking station each authorized user has access to. In addition, the set of ports a user has access to may be based on multi-factor authentication, which corresponds to the amount of authentication provided by the user.

Optionally, at 440, if the user is an authorized user of the docking station, the docking station may lock the computing device to the docking station until the user, or another authorized user, is to authenticate release of the computing device from the docking station. As a result, this may prevent unlocking of the computing device from the docking station when an unauthorized user is to attempt access to the computing device. As an example, the computing device may log attempts to lock and unlock the computing device to and from the docking station, for auditing purposes, to ensure whether or not only authorized users are utilizing the docking station.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method performed by a docking station, the method comprising:
determining whether a computing device is docked to the docking station;
upon determining the computing device is docked to the docking station, determining whether a user associated with the computing device is an authorized user of the docking station; and
if the user is an authorized user of the docking station, enabling ports of the docking station for access by the computing device.

2. The method of claim 1, wherein if the user is not an authorized user of the docking station, preventing access, by the computing device, to peripherals connected to the ports of the docking station.

3. The method of claim 1, wherein if the user is an authorized user of the docking station, locking the computing device to the docking station until the user is to authenticate release of the computing device from the docking station.

4. The method of 3, comprising preventing unlocking of the computing device from the docking station when an unauthorized user is to attempt access to the computing device.

5. The method of claim 3, comprising logging attempts to lock and unlock the computing device to and from the docking station.

6. The method of claim 1, wherein determining whether the user is an authorized user of the docking station comprises looking up a database to determine whether the database includes information concerning the user.

7. The method of claim 6, comprising modifying the database to include other users that are authorized to use the docking station.

8. The method of claim 6, wherein the database comprises set of the ports of the docking station each authorized user has access to.

9. The method of claim 1, wherein the ports enabled is based on multi-factor authentication provided by the user.

10. A docking station comprising:
general-purpose input/output (GPIO) pins;
a radio;
a database; and
an authenticator to:
determine whether a computing device is docked to the docking station;
upon determining the computing device is docked to the docking station, use the radio determine whether a user associated with the computing device is an authorized user of the docking station, wherein determining whether the user is an authorized user comprises looking up the database to determine whether the database includes information concerning the user; and
if the user is an authorized user of the docking station, enable at least a set of the GPIO pins to enable ports of the docking station for access by the computing device.

11. The docking station of claim 10, wherein if the user is not an authorized user of the docking station, the authenticator to disable the GPIO pins to prevent access, by the computing device, to peripherals connected to the ports of the docking station.

12. The docking station of claim 10, wherein if the user is an authorized user of the docking station, the authenticator to enable one of the GPIO pins to lock the computing device to the docking station until the user is to authenticate release of the computing device from the docking station.

13. The docking station of claim 10, the authenticator to log attempts to lock and unlock the computing device to and from the docking station.

14. A non-transitory computer-readable storage medium of a docking station comprising program instructions which, when executed by a processor, to cause the processor to:
determine whether a computing device is docked to the docking station;
upon determining the computing device is docked to the docking station, determine whether a user associated with the computing device is an authorized user of the docking station; and
if the user is an authorized user of the docking station:
enable ports of the docking station for access by the computing device; and
lock the computing device to the docking station until the user is to authenticate release of the computing device from the docking station.

15. The non-transitory computer-readable storage medium of claim 14, wherein when an unauthorized user is to attempt access to the computing device, the processor to:
prevent access, by the computing device, to peripherals connected to the ports of the docking station; and
prevent unlocking of the computing device from the docking station.
